(19) United States
(12) Patent Application Publication
(10) Pub. No.: US 2023/0396444 A1
(43) Pub. Date: Dec. 7, 2023

(54) DATA TRANSACTION MANAGEMENT APPARATUS, DATA TRANSACTION MANAGEMENT METHOD, AND COMPUTER READABLE MEDIUM

(71) Applicant: NEC Corporation, Minato-ku, Tokyo (JP)

(72) Inventor: Makoto Miyasaka, Tokyo (JP)

(73) Assignee: NEC Corporation, Minato-ku, Tokyo (JP)

(21) Appl. No.: 18/032,145

(22) PCT Filed: Oct. 28, 2020
(86) PCT No.: PCT/JP2020/040340

§ 371 Date: Apr. 14, 2023

(51) Int. Cl. H04L 9/32

(52) U.S. Cl. CPC H04L 9/3247; H04L 9/3263

(57) ABSTRACT

A data transaction management apparatus (10) according to the present disclosure includes: a transaction unit (11) configured to conduct a transaction with a data user terminal (40) for providing data to the data user terminal (40); a signature unit (12) configured to generate a signature of transaction information including identification information of the data that has not been processed yet, identification information of an application used for processing, and a time stamp indicating a time when the transaction has been conducted; a processing unit (13) configured to process the data by secure computation using the application; a provision unit (14) configured to provide the processed data to the data user terminal (40); an issuance unit (15) configured to issue a certificate including the signature of the transaction information; and a disclosure unit (16) configured to disclose the certificate.

### TECHNICAL FIELD

The present disclosure relates to a data transaction management apparatus, a data transaction management method, and a computer readable medium.

### BACKGROUND ART

In recent years, a data distribution market in which a data provider can register any data and a data user different from the data provider can acquire the registered data through a transaction has been attracting attention. Further, a system for distributing data is disclosed, for example, in Patent Literature 1.

However, even when a data provider has data that is likely to be in demand, the data provider will not be able to provide the data to a data distribution market if the data includes information which the data provider wants to keep secret, and thus the amount of data and the number of types of data that can be distributed in the data distribution market are reduced.

The above problem that the amount of data and the number of types of data distributed in the data distribution market are reduced can be solved by using a technique called secure computation. Secure computation is a technique for, when computation is performed, making it impossible to refer to contents of processing including contents of a memory except through a program that is performing the computation. Examples of the secure computation include Trusted Execution Environment (TEE) and Multi-Party Computation (MPC).

When data includes information which the data provider wants to keep secret, original data is kept undisclosed by secure computation using an application and then the data is processed so that the information which the data provider wants to keep secret is deleted. By doing the above, it is possible to keep the information secret from data users who have acquired the data from the data distribution market.

### CITATION LIST

### Patent Literature

Patent Literature 1: Japanese Unexamined Patent Application Publication No. 2016-195440

### SUMMARY OF INVENTION

### Technical Problem

As described above, by processing data by secure computation using an application, it is possible to generate processed data without disclosing information which the data provider wants to keep secret included in the data.

However, the processed data is different from original data (i.e., data that has not been processed yet), and the original data is not disclosed. Therefore, a data user who has acquired the processed data needs to confirm whether or not the processed data has been obtained from original data which the data user intends to process.

However, in the related art such as Patent Literature 1, there is no method by which a data user or a third party can confirm original data or an application used for the processing.

Therefore, an object of the present disclosure is to provide a data transaction management apparatus, a data transaction management method, and a computer readable medium that are capable of solving the above-described problem, and confirming, even when data is processed by secure computation using an application, original data and the application used for the processing.

### Solution to Problem

A data transaction management apparatus according to an example aspect includes:
a transaction unit configured to conduct a transaction with a first terminal for providing data to the first terminal;
a signature unit configured to generate a signature of transaction information including identification information of the data that has not been processed yet, identification information of an application used for processing, and a time stamp indicating a time when the transaction has been conducted;
a processing unit configured to process the data by secure computation using the application;
a provision unit configured to provide the processed data to the first terminal;
an issuance unit configured to issue a certificate including the signature of the transaction information; and
a disclosure unit configured to disclose the certificate.

A data transaction management method according to an example aspect is a data transaction management method performed by a data transaction management apparatus, the data transaction management method including:
a transaction step of conducting a transaction with a first terminal for providing data to the first terminal;
a signature step of generating a signature of transaction information including identification information of the data that has not been processed yet, identification information of an application used for processing, and a time stamp indicating a time when the transaction has been conducted;
a processing step of processing the data by secure computation using the application;
a provision step of providing the processed data to the first terminal;
an issuance step of issuing a certificate including the signature of the transaction information; and
a disclosure step of disclosing the certificate.

A computer readable medium according to an example aspect is a non-transitory computer readable medium storing a program for causing a computer to execute:
a transaction procedure for conducting a transaction with a first terminal for providing data to the first terminal;
a signature procedure for generating a signature of transaction information including identification information of the data that has not been processed yet, identification information of an application used for processing, and a time stamp indicating a time when the transaction has been conducted;
a processing procedure for processing the data by secure computation using the application;
a provision procedure for providing the processed data to the first terminal;
an issuance procedure for issuing a certificate including the signature of the transaction information; and
a disclosure procedure for disclosing the certificate.

### Advantageous Effects of Invention

According to the above-described example aspects, it is possible to achieve an effect that a data transaction management apparatus, a data transaction management method, and a computer readable medium that are capable of confirming, even when data is processed by secure computation using an application, original data and the application used for the processing can be provided.

### BRIEF DESCRIPTION OF DRAWINGS

FIG. 1 is a diagram showing an example of a configuration of a data transaction management system including a data transaction management apparatus according to an example embodiment;

FIG. 2 is a diagram for explaining an example of an operation performed when data and an application are registered in the data transaction management apparatus according to the example embodiment;

FIG. 3 is a diagram for explaining an example of an operation performed when a transaction of data is conducted in the data transaction management apparatus according to the example embodiment;

FIG. 4 is a diagram for explaining an example of an operation performed when data is provided in the data transaction management apparatus according to the example embodiment;

FIG. 5 is a diagram for explaining an example of an operation performed when an inquiry about a transaction is made in the data transaction management apparatus according to the example embodiment;

FIG. 6 is a flowchart for explaining an example of a flow of operations performed by the data transaction management apparatus according to the example embodiment; and

FIG. 7 is a block diagram showing an example of a hardware configuration of a computer that implements the data transaction management apparatus according to the example embodiment.

### EXAMPLE EMBODIMENT

An example embodiment of the present disclosure will be described hereinafter with reference to the drawings. Note that, for the clarification of the description, the following descriptions and the drawings are partially omitted and simplified as appropriate. Further, the same elements are denoted by the same reference symbols throughout the drawings, and redundant descriptions are omitted as necessary.

### Example Embodiment

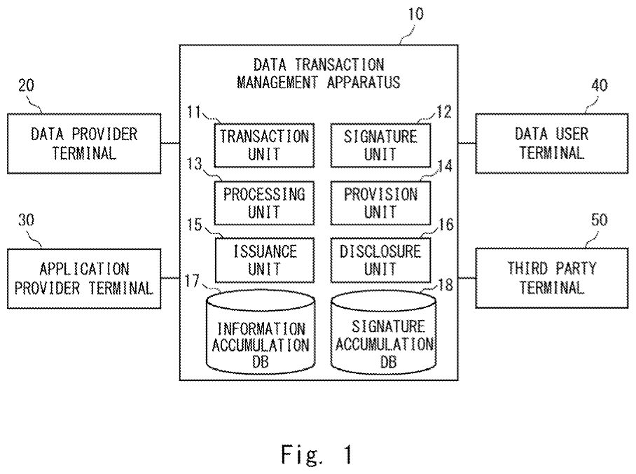

First, an example of a configuration of a data transaction management system including a data transaction management apparatus 10 according to this example embodiment will be described with reference to FIG. 1.

As shown in FIG. 1, the data transaction management apparatus 10 according to this example embodiment is incorporated into the data transaction management system and used. The data transaction management apparatus 10 is an apparatus for managing transactions of data in a data transaction market.

The data transaction management system shown in FIG. 1 includes a data provider terminal 20, an application provider terminal 30, a data user terminal 40, and a third party terminal 50 in addition to the data transaction management apparatus 10. Note that the data user terminal 40 is an example of a first terminal, and the third party terminal 50 is an example of a second terminal.

The data provider terminal 20 is a terminal used by the data provider to provide original data to be processed by secure computation.

The application provider terminal 30 is a terminal used by an application provider to provide an application used for processing by secure computation.

The data user terminal 40 is a terminal used by a data user to acquire (purchase) processed data processed by secure computation.

The third party terminal 50 is a terminal used by a third party to confirm original data, an application used for processing, and the fact that a data user has the rights to the processed data.

The data transaction management apparatus 10 includes a transaction unit 11, a signature unit 12, a processing unit 13, a provision unit 14, an issuance unit 15, a disclosure unit 16, an information accumulation DB, i.e., Data Base (hereinafter, DB) 17, and a signature accumulation DB 18.

The transaction unit 11 conducts a transaction with the data user terminal 40 for providing data to the data user terminal 40. In the transaction, the data user terminal 40 specifies data to be provided by the transaction unit 11, and the transaction unit 11 performs processing such as charging.

The signature unit 12 generates a signature of original data to be processed by the processing unit 13 which will be described later, a signature of the processed data processed by the processing unit 13, and a signature of an application used for the processing. Further, the signature unit 12 generates a signature of transaction information including identification information (e.g., a user name) of a data user who uses the data user terminal 40 that provides data by the transaction, identification information (e.g., a data name) of the original data, identification information (e.g., an application name) of the application used for the processing, and a time stamp indicating the time when the transaction has been conducted.

The processing unit 13 processes the original data specified by the data user terminal 40 by secure computation using an application. For example, the processing unit 13 performs processing of deleting information which the data provider wants to keep secret from the original data. Note that an application used for the processing may be specified by the data provider terminal 20 or by the data user terminal 40.

The provision unit 14 provides the processed data processed by the processing unit 13 to the data user terminal 40. At this time, the provision unit 14 may attach, to the processed data, a signature of the processed data generated by the signature unit 12, a key for decrypting the processed data, and a certificate issued by the issuance unit 15 which will be described later.

The issuance unit 15 issues a certificate including a signature of transaction information.

The disclosure unit 16 discloses the certificate issued by the issuance unit 15. Further, when the disclosure unit 16 receives a request for inquiry about the transaction for which the signature of the transaction information is specified from the third party terminal 50, the disclosure unit 16 provides the third party terminal 50 with identification information of the data user, identification information of the original data, and identification information of the application that are included in the transaction information. Note that the disclosure unit 16 performs an operation similar to the above operation when it receives a request for inquiry about the transaction from the data user terminal 40.

The information accumulation DB 17 accumulates original data, processed data, applications, and transaction information.

The signature accumulation DB 18 accumulates signatures of original data, signatures of processed data, signatures of applications, and signatures of transaction information.

Note that the information accumulation DB 17 and the signature accumulation DB 18 are not essential components in the data transaction management apparatus 10, and may be provided outside the data transaction management apparatus 10. That is, the data transaction management apparatus 10 may be implemented by a minimum configuration composed of the transaction unit 11, the signature unit 12, the processing unit 13, the provision unit 14, the issuance unit 15, and the disclosure unit 16.

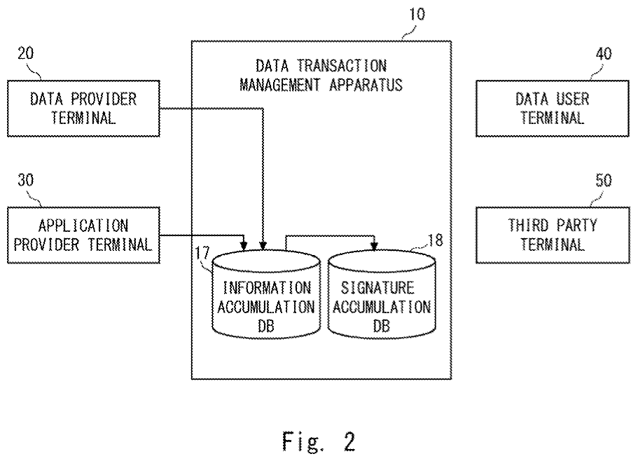

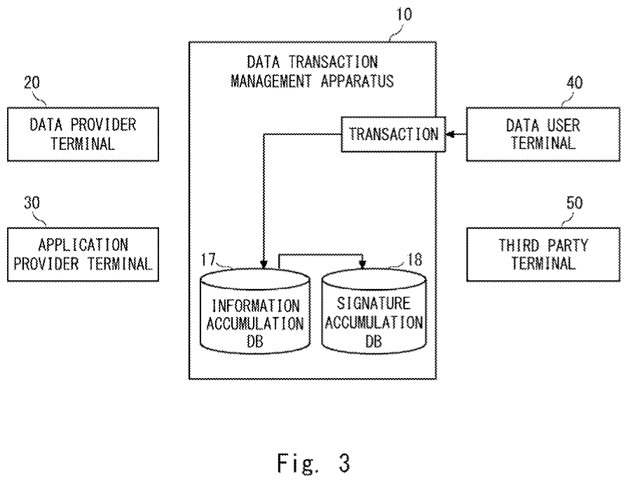

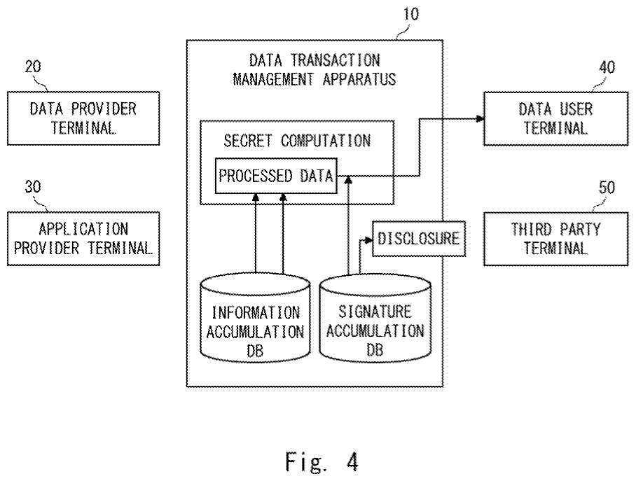

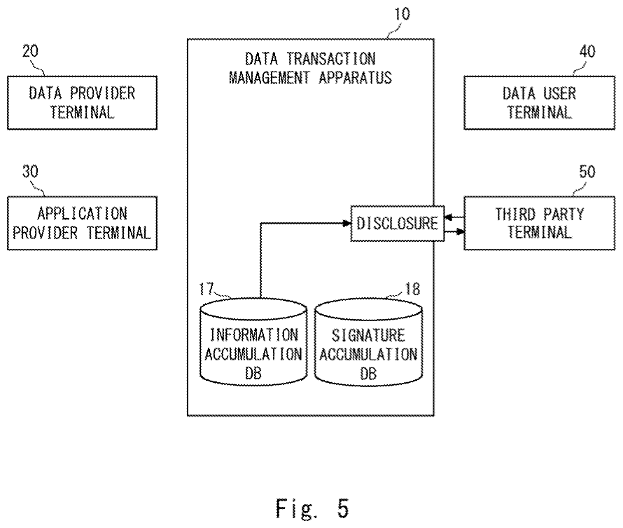

Next, examples of operations performed by the data transaction management apparatus 10 according to this example embodiment will be described with reference to FIGS. 2 to 5. Regarding the operations performed by the data transaction management apparatus 10, that is, the operation performed when data and an application are registered (FIG. 2), the operation performed when a transaction of data is conducted (FIG. 3), the operation performed when data is provided (FIG. 4), and the operation performed when an inquiry about a transaction is made (FIG. 5), will be described separately below. Note that, in the following description, it is assumed that the data provider terminal 20, the application provider terminal 30, the data user terminal 40, and the third party terminal 50 have been configured in advance so that they can use the data transaction management apparatus 10. Further, in FIGS. 2 to 5, the illustration of each of the transaction unit 11, the signature unit 12, the processing unit 13, the provision unit 14, the issuance unit 15, and the disclosure unit 16 in the data transaction management apparatus 10 is omitted so as to clarify the description.

First, an example of the operation performed when data and an application are registered in the data transaction management apparatus 10 will be described with reference to FIG. 2.

As shown in FIG. 2, the data provider terminal 20 registers original data in the information accumulation DB 17 in advance, and the application provider terminal 30 registers an application used for processing in the information accumulation DB 17 in advance. These registrations may be performed through any component (e.g., the transaction unit 11) in the data transaction management apparatus 10.

Next, the signature unit 12 generates a signature of each of the original data and the application registered in the information accumulation DB 17. These signatures may be generated by any method, and, for example, a hash value may be used as a signature. Next, the signature unit 12 registers the generated signatures in the signature accumulation DB 18. At this time, the original data and the application registered in the information accumulation DB 17 and their respective signatures registered in the signature accumulation DB 18 are associated with each other, for example, by adding identification information of the transaction thereto and registering them.

Next, an example of the operation performed when a transaction of data is conducted in the data transaction management apparatus 10 will be described with reference to FIG. 3.

As shown in FIG. 3, the transaction unit 11 first conducts a transaction with the data user terminal 40 for providing data to the data user terminal 40. In this transaction, the data user terminal 40 specifies data to be provided by the transaction unit 11. Next, based on a result of the transaction, the transaction unit 11 registers, in the information accumulation DB 17, transaction information including identification information of a data user who uses the data user terminal 40, identification information of original data, identification information of an application used for processing, and a time stamp indicating the time when the transaction has been conducted.

Next, the signature unit 12 generates a signature of the transaction information. This signature may be generated by any method, and, for example, a hash value may be used as a signature. Next, the signature unit 12 registers the generated signature in the signature accumulation DB 18. At this time, the transaction information registered in the information accumulation DB 17 and the signature of the transaction information registered in the signature accumulation DB 18 are associated with each other, for example, by adding identification information of the transaction thereto and registering them.

Next, an example of the operation performed when data is provided in the data transaction management apparatus 10 will be described with reference to FIG. 4. Note that the operation shown in FIG. 4 is started at the timing when the operation shown in FIG. 3 is ended.

As shown in FIG. 4, the processing unit 13 first retrieves the original data and the application specified by the data user terminal 40 from the information accumulation DB 17, and processes the original data by secure computation using the application.

Next, the signature unit 12 generates a signature of the processed data processed by the processing unit 13. This signature is preferably generated by a Public Key Infrastructure (PKI) method. Therefore, the signature unit 12 generates the signature of the processed data by encrypting the hash value of the processed data with a private key. Next, the signature unit 12 registers the generated signature in the signature accumulation DB 18. At this time, the processed data registered in the information accumulation DB 17 and the signature of the processed data registered in the signature accumulation DB 18 are associated with each other, for example, by adding identification information of the transaction thereto and registering them.

Then, the provision unit 14 attaches the signature of the processed data, a public key for decrypting the processed data, and the signature of the transaction information retrieved from the signature accumulation DB 18 to the processed data processed by the processing unit 13, and provides it to the data user terminal 40. Note that the signature of the public key and the signature of the transaction information may be attached to the processed data in the form of a certificate issued by the issuance unit 15. However, the attachment of the signature of the transaction information to the processed data may be optional. Further, when a key is provided by a platform of secure computation performed by the processing unit 13, it is possible to certify the platform on which the secure computation has been performed by using this key.

Next, the issuance unit 15 retrieves the signature of the transaction information from the signature accumulation DB 18 and issues a certificate including the retrieved signature of the transaction information. The disclosure unit 16 discloses the certificate issued by the issuance unit 15.

As described above, the disclosure unit 16 discloses the certificate including the signature of the transaction information. By doing so, the third party terminal 50 and the data user terminal 40 can specify the signature of the transaction information included in the certificate and then make a request for inquiry about the transaction. As a result, the third party terminal 50 and the data user terminal 40 can confirm the original data, the application used for the processing, and the fact that the data user has the right to the processed data, since they can confirm the data user, the original data, and the application included in the transaction information.

Next, an example of the operation performed when an inquiry about a transaction is made in the data transaction management apparatus 10 will be described with reference to FIG. 5. FIG. 5 shows an example of the operation when the third party terminal 50 makes a request for inquiry about a transaction.

As shown in FIG. 5, when the disclosure unit 16 receives a request for inquiry about the transaction for which the signature of the transaction information is specified from the third party terminal 50, the disclosure unit 16 first retrieves the transaction information associated with the signature of the transaction information from the information accumulation DB 17. Next, the disclosure unit 16 provides the third party terminal 50 with identification information of the data user, identification information of the original data, and identification information of the application that are included in the transaction information. Note that the disclosure unit 16 performs an operation similar to the above operation when it receives a request for inquiry about the transaction from the data user terminal 40.

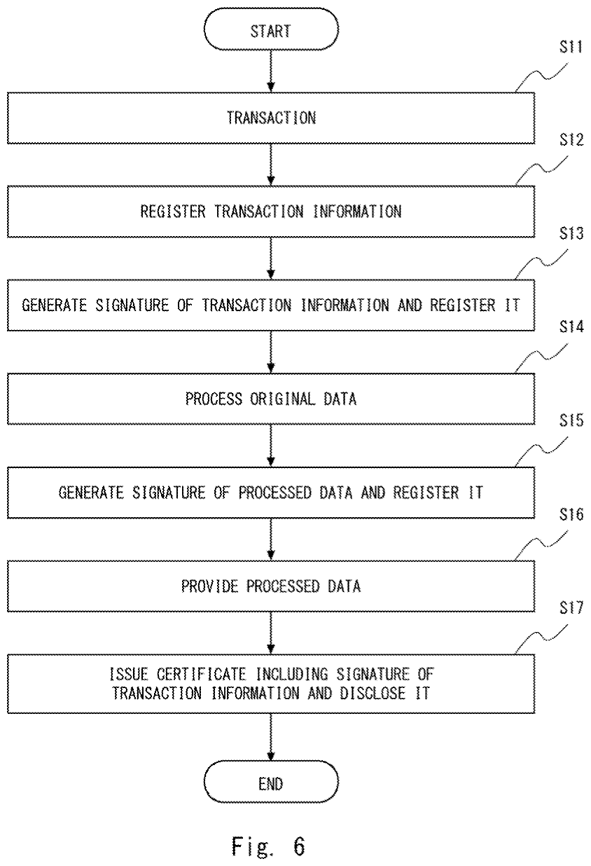

Next, an example of a flow of the operation performed by the data transaction management apparatus 10 according to this example embodiment will be described with reference to FIG. 6. Note that FIG. 6 shows operations equivalent to the operations from the operation performed when a transaction of data is conducted described with reference to FIG. 3 to the operation performed when data is provided described with reference to FIG. 4.

As shown in FIG. 6, the transaction unit 11 first conducts a transaction with the data user terminal 40 for providing data to the data user terminal 40 (Step S11). In this transaction, the data user terminal 40 specifies data to be provided by the transaction unit 11.

Next, based on a result of the transaction, the transaction unit 11 registers, in the information accumulation DB 17, transaction information including identification information of a data user who uses the data user terminal 40, identification information of original data, identification information of an application used for processing, and a time stamp indicating the time when the transaction has been conducted (Step S12).

Next, the signature unit 12 generates a signature of the transaction information and registers the generated signature in the signature accumulation DB 18 (Step S13).

Next, the processing unit 13 retrieves the original data and the application specified by the data user terminal 40 from the information accumulation DB 17, and processes the original data by secure computation using the application (Step S14).

Next, the signature unit 12 generates a signature of the processed data processed by the processing unit 13 and registers the generated signature in the signature accumulation DB 18 (Step S15).

Next, the provision unit 14 provides the processed data processed by the processing unit 13 to the data user terminal 40 (Step S16). At this time, the provision unit 14 may attach the signature of the processed data to the processed data. Further, when it is necessary to decrypt the processed data with a key, the provision unit 14 may attach the key to the processed data. Further, the provision unit 14 may attach the signature of the transaction information to the processed data.

Then, the issuance unit 15 retrieves the signature of the transaction information from the signature accumulation DB 18 and issues a certificate including the retrieved signature of the transaction information, and the disclosure unit 16 discloses the certificate issued by the issuance unit 15 (Step S17).

As described above, according to the first example embodiment, the transaction unit 11 conducts a transaction with the data user terminal 40 for providing data to the data user terminal 40. The signature unit 12 generates a signature of transaction information including identification information of a data user, identification information of original data, identification information of an application used for processing, and a time stamp indicating the time when the transaction has been conducted. The processing unit 13 processes the original data by secure computation using the application, and the provision unit 14 provides the processed data to the data user terminal 40. The issuance unit 15 issues a certificate including the signature of the transaction information, and the disclosure unit 16 discloses the issued certificate.

By doing the above, the third party terminal 50 and the data user terminal 40 can specify the signature of the transaction information included in the certificate and then make a request for inquiry about the transaction. Therefore, the third party terminal 50 and the data user terminal 40 can confirm the original data, the application used for the processing, and the fact that the data user has the right to the processed data.

### Other Example Embodiments

In the above-described example embodiment, although original data, an application, and transaction information are registered in the information accumulation DB 17, it is preferable that the aforementioned transaction information and the like be stored for a certain period of time and maintained in a state where signatures can be generated again. When the transaction information and the like are deleted from the information accumulation DB 17, signatures cannot be generated again and reproducibility of the certificates cannot be ensured. Therefore, by storing the transaction information and the like in the information accumulation DB 17 for a certain period of time, reproducibility of the certificates can be ensured and the original data and the like can be certified for a long period of time.

Further, in the above-described example embodiment, signatures are registered in the signature accumulation DB 18 in the data transaction management apparatus 10 that manages transactions of data in a data transaction market. However, signature tampering may occur inside the data distribution market. Therefore, in order to prevent the signature accumulation DB 18 from being tampered with inside the data transaction market, it is preferable to take measures to prevent tampering with the signature accumulation DB 18. One possible measure to prevent the tampering is to accumulate signatures by a blockchain method. Alternatively, a certificate may be generated using an external certificate authority.

Further, in the above-described example embodiment, although transaction information includes identification information of a data user, the present disclosure is not limited thereto. For example, a data user who has acquired processed data may be confirmed (i.e., identified), for example, by tracing the data user from identification information of the transaction. In this way, it may be possible to confirm the data user who has acquired processed data by using other means. Therefore, the inclusion of the identification information of the data user in the transaction information may be optional.

Further, in the above-described example embodiment, although the signature unit 12 generates the signature of the processed data by a PKI method, the present disclosure is not limited thereto. The signature unit 12 may generate the signature of the processed data by encrypting the processed data using any encryption platform.

Further, in the above-described example embodiment, although it is assumed that the data provider terminal 20 registers original data in the information accumulation DB 17 without encrypting the original data, the present disclosure is not limited thereto. The data provider terminal 20 may encrypt the original data and then register the encrypted data in the information accumulation DB 17.

Further, in the above-described example embodiment, although it is assumed that the components in the data provider terminal 20 are disposed in one housing, the present disclosure is not limited thereto. The components in the data provider terminal 20 may be disposed in a plurality of housings in a distributed manner.

### <Hardware Configuration of the Data Transaction Management Apparatus According to the Example Embodiment>

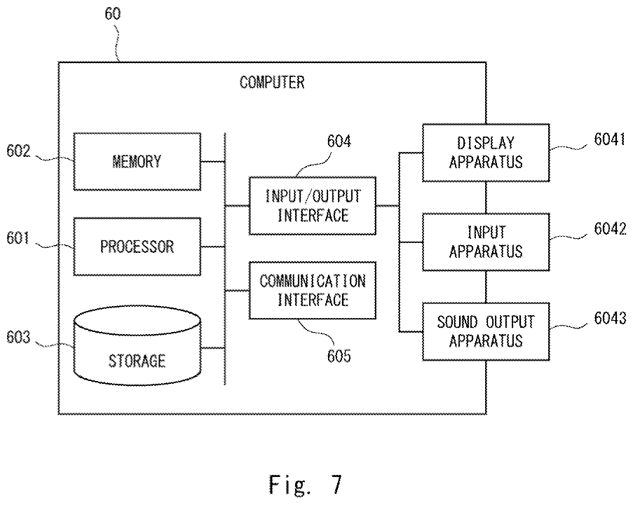

Next, a hardware configuration of a computer 60 that implements the data transaction management apparatus 10 according to the above-described example embodiment will be described with reference to FIG. 7. Note that it is assumed that the computer 60 shown in FIG. 7 implements the data transaction management apparatus 10 in which the components are disposed in one housing.

As shown in FIG. 7, the computer 60 includes a processor 601, a memory 602, a storage 603, an input/output interface (an input/output I/F) 604, a communication interface (a communication I/F) 605, and the like. The processor 601, the memory 602, the storage 603, the input/output interface 604, and the communication interface 605 are connected to each other through data transmission lines through which they transmit/receive data to/from each other.

The processor 601 is, for example, an arithmetic processing unit such as a Central Processing Unit (CPU) or a Graphics Processing Unit (GPU). The memory 602 is, for example, a memory such as a Random Access Memory (RAM) or a Read Only Memory (ROM). The storage 603 is, for example, a storage device such as a Hard Disk Drive (HDD), a Solid State Drive (SSD), or a memory card. Further, the storage 603 may be a memory such as a RAM or a ROM.

The storage 603 stores programs for implementing the functions of the components included in the data transaction management apparatus 10. The processor 601 implements the function of each of the components included in the data transaction management apparatus 10 by executing the respective programs. Note that when the processor 601 executes these respective programs, it may execute the programs after loading them onto the memory 602 or may execute the programs without loading them onto the memory 602. Further, the memory 602 and the storage 603 also have a function of storing information and data held by the components included in the data transaction management apparatus 10.

Further, the above-described program(s) can be stored and provided to a computer (including the computer 60) using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Compact Disc-ROM), CD-R (CD-Recordable), CD-R/W (CD-ReWritable), and semiconductor memories (such as mask ROM, PROM (Programmable ROM), EPROM (Erasable PROM), flash ROM, RAM, etc.). Further, the program(s) may be provided to a computer using any type of transitory computer readable media. Examples of transitory computer readable media include electric signals, optical signals, and electromagnetic waves. Transitory computer readable media can provide the program(s) to a computer via a wired communication line (e.g., electric wires and optical fibers) or a wireless communication line.

The input/output interface 604 is connected to a display apparatus 6041, an input apparatus 6042, a sound output apparatus 6043, and the like. The display apparatus 6041 is an apparatus, such as a Liquid Crystal Display (LCD), a Cathode Ray Tube (CRT) display, or a monitor, which displays a screen corresponding to drawing data processed by the processor 601. The input apparatus 6042 is an apparatus that receives an operation input from an operator, and is, for example, a keyboard, a mouse, and a touch sensor. The display apparatus 6041 and the input apparatus 6042 may be integrated with each other and hence implemented as a touch panel. The sound output apparatus 6043 is an apparatus, such as a speaker, which outputs sounds corresponding to acoustic data processed by the processor 601.

The communication interface 605 transmits and receives data to and from an external apparatus. For example, the communication interface 605 communicates with an external apparatus through a wired communication line or a wireless communication line.

Although the present disclosure has been described with reference to the example embodiments, the present disclosure is not limited to the above-described example embodiments. Various changes that may be understood by those skilled in the art may be made to the configurations and details of the present disclosure within the scope of the disclosure.

Further, the whole or part of the example embodiments disclosed above can be described as, but not limited to, the following supplementary notes.

(Supplementary Note 1)

A data transaction management apparatus comprising:
a transaction unit configured to conduct a transaction with a first terminal for providing data to the first terminal;
a signature unit configured to generate a signature of transaction information including identification information of the data that has not been processed yet, identification information of an application used for processing, and a time stamp indicating a time when the transaction has been conducted;
a processing unit configured to process the data by secure computation using the application;
a provision unit configured to provide the processed data to the first terminal;
an issuance unit configured to issue a certificate including the signature of the transaction information; and
a disclosure unit configured to disclose the certificate.

(Supplementary Note 2)

The data transaction management apparatus according to Supplementary note 1, wherein when the disclosure unit receives, from the first terminal or a second terminal, a request for inquiry about the transaction specifying the signature of the transaction information, the disclosure unit provides the first or the second terminal with the identification information of the data that has not been processed yet and the identification information of the application that are included in the transaction information.

(Supplementary Note 3)

The data transaction management apparatus according to Supplementary note 2, wherein
the transaction information further includes identification information of a user who uses the first terminal, and
when the disclosure unit receives, from the first or the second terminal, the request for inquiry about the transaction, the disclosure unit provides the first or the second terminal with the identification information of the data that has not been processed yet, the identification information of the application, and the identification information of the user that are included in the transaction information.

(Supplementary Note 4)

The data transaction management apparatus according to any one of Supplementary notes 1 to 3, wherein the provision unit attaches the certificate to the processed data, and provides the processed data to which the certificate is attached to the first terminal.

(Supplementary Note 5)

The data transaction management apparatus according to any one of Supplementary notes 1 to 4, wherein
the signature unit generates a signature of the processed data by encrypting the processed data using an encryption platform, and
the provision unit provides the processed data and the signature of the processed data to the first terminal.

(Supplementary Note 6)

A data transaction management method performed by a data transaction management apparatus, the data transaction management method comprising:
a transaction step of conducting a transaction with a first terminal for providing data to the first terminal;
a first signature step of generating a signature of transaction information including identification information of the data that has not been processed yet, identification information of an application used for processing, and a time stamp indicating a time when the transaction has been conducted;
a processing step of processing the data by secure computation using the application;
a provision step of providing the processed data to the first terminal;
an issuance step of issuing a certificate including the signature of the transaction information; and
a disclosure step of disclosing the certificate.

(Supplementary Note 7)

The data transaction management method according to Supplementary note 6, wherein in the disclosure step, when a request for inquiry about the transaction specifying the signature of the transaction information is received from the first terminal or a second terminal, the identification information of the data that has not been processed yet and the identification information of the application that are included in the transaction information are provided to the first or the second terminal.

(Supplementary Note 8)

The data transaction management method according to Supplementary note 7, wherein
the transaction information further includes identification information of a user who uses the first terminal, and
in the disclosure step, when the request for inquiry about the transaction is received from the first or the second terminal, the identification information of the data that has not been processed yet, the identification information of the application, and the identification information of the user that are included in the transaction information are provided to the first or the second terminal.

(Supplementary Note 9)

The data transaction management method according to any one of Supplementary notes 6 to 8, wherein in the provision step, the certificate is attached to the processed data, and the processed data to which the certificate is attached is provided to the first terminal.

(Supplementary Note 10)

The data transaction management method according to any one of Supplementary notes 6 to 9, further comprising a second signature step of generating a signature of the processed data by encrypting the processed data using an encryption platform,
wherein in the provision step, the processed data and the signature of the processed data are provided to the first terminal.

(Supplementary Note 11)

A non-transitory computer readable medium storing a program for causing a computer to execute:
a transaction procedure for conducting a transaction with a first terminal for providing data to the first terminal;
a signature procedure for generating a signature of transaction information including identification information of the data that has not been processed yet, identification information of an application used for processing, and a time stamp indicating a time when the transaction has been conducted;
a processing procedure for processing the data by secure computation using the application;
a provision procedure for providing the processed data to the first terminal;
an issuance procedure for issuing a certificate including the signature of the transaction information; and
a disclosure procedure for disclosing the certificate.

### REFERENCE SIGNS LIST

10 DATA TRANSACTION MANAGEMENT APPARATUS
11 TRANSACTION UNIT
12 SIGNATURE UNIT
13 PROCESSING UNIT
14 PROVISION UNIT
15 ISSUANCE UNIT
16 DISCLOSURE UNIT
17 INFORMATION ACCUMULATION DB
18 SIGNATURE ACCUMULATION DB
20 DATA PROVIDER TERMINAL
30 APPLICATION PROVIDER TERMINAL
40 DATA USER TERMINAL
50 THIRD PARTY TERMINAL
60 COMPUTER
601 PROCESSOR
602 MEMORY
603 STORAGE
604 INPUT/OUTPUT INTERFACE
6041 DISPLAY APPARATUS
6042 INPUT APPARATUS
6043 SOUND OUTPUT APPARATUS
605 COMMUNICATION INTERFACE

What is claimed is:

1. A data transaction management apparatus comprising:
at least one memory storing instructions, and
at least one processor configured to execute the instructions to:
conduct a transaction with a first terminal for providing data to the first terminal;
generate a signature of transaction information including identification information of the data that has not been processed yet, identification information of an application used for processing, and a time stamp indicating a time when the transaction has been conducted;
process the data by secure computation using the application;
provide the processed data to the first terminal;
issue a certificate including the signature of the transaction information; and
disclose the certificate.

2. The data transaction management apparatus according to claim 1, wherein
upon receiving, from the first terminal or a second terminal, a request for inquiry about the transaction specifying the signature of the transaction information, the at least one processor is further configured to execute the instructions to provide the first or the second terminal with the identification information of the data that has not been processed yet and the identification information of the application that are included in the transaction information.

3. The data transaction management apparatus according to claim 2, wherein
the transaction information further includes identification information of a user who uses the first terminal, and
upon receiving, from the first or the second terminal, the request for inquiry about the transaction, the at least one processor is further configured to execute the instructions to provide the first or the second terminal with the identification information of the data that has not been processed yet, the identification information of the application, and the identification information of the user that are included in the transaction information.

4. The data transaction management apparatus according to claim 1, wherein the at least one processor is further configured to execute the instructions to attach the certificate to the processed data, and provide the processed data to which the certificate is attached to the first terminal.

5. The data transaction management apparatus according to claim 1, wherein
the at least one processor is further configured to execute the instructions to:
generate a signature of the processed data by encrypting the processed data using an encryption platform, and
provide the processed data and the signature of the processed data to the first terminal.

6. A data transaction management method performed by a data transaction management apparatus, the data transaction management method comprising:
a transaction step of conducting a transaction with a first terminal for providing data to the first terminal;
a first signature step of generating a signature of transaction information including identification information of the data that has not been processed yet, identification information of an application used for processing, and a time stamp indicating a time when the transaction has been conducted;
a processing step of processing the data by secure computation using the application;
a provision step of providing the processed data to the first terminal;
an issuance step of issuing a certificate including the signature of the transaction information; and
a disclosure step of disclosing the certificate.

7. The data transaction management method according to claim 6, wherein in the disclosure step, when a request for inquiry about the transaction specifying the signature of the transaction information is received from the first terminal or a second terminal, the identification information of the data that has not been processed yet and the identification information of the application that are included in the transaction information are provided to the first or the second terminal.

8. The data transaction management method according to claim 7, wherein
the transaction information further includes identification information of a user who uses the first terminal, and
in the disclosure step, when the request for inquiry about the transaction is received from the first or the second terminal, the identification information of the data that has not been processed yet, the identification information of the application, and the identification information of the user that are included in the transaction information are provided to the first or the second terminal.

9. The data transaction management method according to claim 6, wherein in the provision step, the certificate is attached to the processed data, and the processed data to which the certificate is attached is provided to the first terminal.

10. The data transaction management method according to claim 6, further comprising a second signature step of generating a signature of the processed data by encrypting the processed data using an encryption platform,
wherein in the provision step, the processed data and the signature of the processed data are provided to the first terminal.

11. A non-transitory computer readable medium storing a program for causing a computer to execute:
a transaction procedure for conducting a transaction with a first terminal for providing data to the first terminal;
a signature procedure for generating a signature of transaction information including identification information of the data that has not been processed yet, identification information of an application used for processing, and a time stamp indicating a time when the transaction has been conducted;
a processing procedure for processing the data by secure computation using the application;
a provision procedure for providing the processed data to the first terminal;
an issuance procedure for issuing a certificate including the signature of the transaction information; and
a disclosure procedure for disclosing the certificate.
